(19) United States
(12) Patent Application Publication
(10) Pub. No.: US 2002/0156815 A1
(43) Pub. Date: Oct. 24, 2002

(54) Method and apparatus for the separation of web layout, logic, and data when used in server-side scripting languages

(75) Inventor: Christopher Jay Davia, Mableton, GA (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/838,653

(22) Filed: Apr. 19, 2001

(51) Int. Cl. G06F 17/24; G06F 17/00

(52) U.S. Cl. 707/517; 707/513

(57) ABSTRACT

Disclosed is a method of providing content for display of a web page. The method comprises: generating a dynamic content frame separate from a static content frame comprising layout and logic information during development of said web page; and downloading said dynamic content frame independently of said static content frame. Dynamic content is downloaded whenever a new web page is requested. The Dynamic content calls general functions of the static content frame that acts upon the logic and layout of the static content frame. Logic for the web page (i.e., how it acts, looks, etc.) is stored separately but referenced in the dynamic content. Therefore, the browser does not need to re-download the same logic for subsequent screens. In this manner, a more efficient download and display of the web page is achieved. Thus, the invention reduces download time of web content for web pages having similar logic and layout.

### BACKGROUND OF THE INVENTION

1. Technical Field

The present invention relates in general to web pages, and in particular to displaying content within a web page. Still more particular, the present invention relates to a method and system for displaying content on a web page that allows independent manipulation of the content's layout, logic, and data.

2. Description of the Related Art

Web pages generally contain graphical and textual information retrieved from an Internet server and displayed in a particular layout with pre-set interactive logic (i.e., logic for responding to user selection of items, etc.). Typically, the information that is contained is designed utilizing scripting languages, which provides easier browsing operations to a user of web pages. Scripting languages may be designed for both the client-side and server-side of the Internet exchange. In recent years, there has been a proliferation of server-side scripting languages that are utilized for web development. These server-side scripting languages were created to reduce the client-side processing of web data by moving some of the processing to the web server. The relocation of the processing to the web server allows for a reduction in the size of the web content, and thus, a reduction in the time needed to download and process the web content.

Server-side scripting languages are implemented in one of two ways: (1) a proprietary scripting language is embedded within the web page, for example, Active Server Pages (ASP), or Java Server Pages (JSP), both of which are scripted within a Hypertext Markup Language (HTML) file; and (2) the web page (e.g., the HTML file) is embedded within a proprietary server-side scripting language, such as, for example, IBM Net Data created by International Business Machines, Corporation.

Both of the above approaches require a tightly-coupled integration of web content with the server-side scripting language, and consequently, the web content is difficult to develop, maintain, and/or enhance. For example, IBM Net Data macro is a proprietary server-side scripting language that requires the HTML content to be developed, maintained, and enhanced. However, since the Net Data language is proprietary, no off-the-shelf web content development packages can be utilized to develop, maintain, or enhance the web content. Thus, it becomes especially difficult to create, display, and edit Net Data macros within HTML content.

The common approach to the above problem is to develop the web content independently of the server-side script. The web content is then copied, modified slightly, and pasted into various parts of the server-side script. However, this solution becomes extremely difficult to maintain because the layout, content, and logic of the web content cannot be edited without editing the server-side script or client-side logic.

The present invention recognizes that it would therefore be advantageous and desirable to have a system and method that allows the separate manipulation of the logic, layout, and data of the web content of a server side application to allow independent manipulation of web content for web pages. The invention further recognizes that it would be desirable to reduce download time for sequentially downloaded web content with similar logic and layout. These and other benefits are provided by the present invention.

### SUMMARY OF THE INVENTION

Disclosed is a method of providing content for display of a web page. The method comprises: generating a dynamic content frame separate from a static content frame comprising layout and logic information during development of said web page; and downloading said dynamic content independently of said static content frame.

Dynamic content is downloaded whenever a new web page is requested. The Dynamic content calls general functions of the static content frame that acts upon the logic and layout of the static content frame. Logic for the web page (i.e., how it acts, looks, etc.) is stored separately but referenced in the dynamic content. Therefore, the browser does not need to re-download the same logic for subsequent screens. In this manner, a more efficient download and display of the web page is achieved. Thus, the invention reduces download time of web content for web pages having similar logic and layout.

In one embodiment, the static content frame maintains layout information of a web page content and references an HTML file that includes a Javascript library to add, move, remove and change text and images in a display layer of said web page, and the dynamic content frame created utilizing server-side scripting language that maintains changing information including text data, images, and audio data. The features of the static content frame and the dynamic content frame are merged to provide the display frame utilizing linking information provided within the dynamic content frame. The linking information comprises HTML/Javascript function calls to said static content frame.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of the data processing system for implementing the present web content display within a web page;

FIG. 2 is a block diagram illustrating the traditional method of displaying the images of a web page, according to the prior art; and

FIG. 3 is a block diagram of the new display format for a web page in accordance with one preferred embodiment of the invention.

### DETAILED DESCRIPTION OF AN ILLUSTRATIVE EMBODIMENT

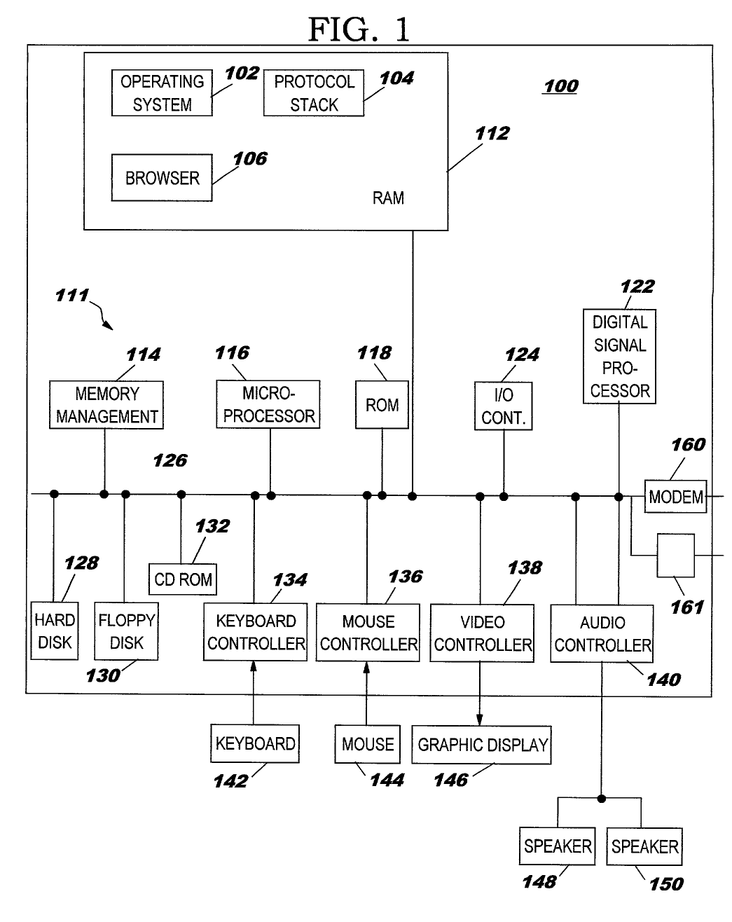

With reference now to the figures and in particular with reference to FIG. 1, an overall data processing system 100 with which the features of the present invention may preferably be implemented is displayed. Data processing system 100 is generally a computer system that provides Internet access and browsing of web pages.

Data processing system 100 has a number of computer sub-component attached to and in communications with each other via a communications bus 126. The various computer sub-systems coupled to the bus 126 include but are not limited to the following systems or devices: memory management system 114, microprocessor 116, read only memory (ROM) system 118, random access memory (RAM) system 112, input/output (1/0) controller 124, digital signal processor 122, hard disk 128, floppy disk 130, CD ROM 132, keyboard controller 134, mouse controller 136, video controller 138, and audio controller 140. I/O controller 124 generally handles communications from/to input/output devices. Data processing system 100 further includes a modem 160 and/or network card 161 by which data processing system 100 is connected to a network that supports a server-side application that provides the downloadable web page manipulated by the present invention.

Data processing system 100 includes several external components coupled to respective ones of internal components. These include keyboard 142, coupled to keyboard controller 134, mouse 144, coupled to mouse controller 136 and speakers 148 and 150, coupled to audio controller 140. Additionally, external components includes graphic display 146, coupled to video controller 138. Graphic display 146 provides a user/developer of a web page to visually interact with web content as the content is being manipulated by one or more of the other external components, such as mouse 144 and keyboard 142.

RAM system 112 is divided into at least the following memory allocations: 1) operating system 102; 2) protocol stack 104; and 3) browser or web browser 106; The present invention provides specific programmed features of web browser 106, which permit the independent manipulation of web content, layout and logic for displayed web pages, as is described in detail below. Although the invention is described with specific reference to data processing system 100, the invention is not in any way limited to the specific hardware disclosed above for data processing system 100, and any suitable system, sub-components, and/or other device may be utilized to implement the present invention.

The present invention enhances the development, maintenance, and/or enhancement of web pages via non-proprietary sever-side scripting applications to permit independent manipulation of the layout, logic, and content of the web page. The invention finds applicability to any server-side scripting language utilized to develop the web page. Primarily, the invention comprises separating the logic, layout, and data of the content of the web page into individual, unique and independently selectable or manipulable components. Further, the invention reduces the download time of subsequent screens (or pages) sharing the same logic and/or layout, therefore reducing the download and processing time necessary to display the web pages.

In the preferred embodiment, the layout of the displayed screen (on graphical display 146) appears similar to the regular web content that is created and edited with off-the-shelf editors. The invention is implemented utilizing software logic that is created to define the functions of the screen to add, remove, and edit data. The data of the web content is created utilizing the server side scripting language selected by the developer or programmer, and the overall web content development is completed utilizing multiple HTML frames and Javascript functions.

The invention provides clearly defined roles and responsibilities for content creators, and also allows the content to be easily maintained or updated. Implementation of the invention involves the utilization of HTML frames, DHTML layers, and Javascript logic. Instead of integrating the layout, logic, and data of a screen, the layout, logic, and data of a screen are all developed separately using appropriate editors.

With the features of the invention, the layout of the web content may thus be created, selected and modified with an off-the-shelf web content editor apart from the server-side script and logic. Also, the logic of the screen may be created and modified apart from the layout and server-side script. Finally, the server-side script may be created and modified apart from the layout and logic.

The following code represents a standard Net Data macro. As provided, the HTML layout, Javascript logic, and net data script are all integrated in the same file and, because external HTML editors cannot edit this file, changing the layout, logic, or script becomes extremely difficult.

%DEFINE{

DATABASE+“sample”

LOGIN=“userid”

PASSWORD=“password”

SHOWSQL=“NO”

table1=“EMPLOYEE”

%}

%FUNCTION(DTW_SQL)query1( ){

select count (*) from $(table1)

%}

%HTML (REPORT){

<HTML>

<TITLE>REPORT Title Goes Here</TITLE

<P>

@query1( )

<p>

</HTML>

%}

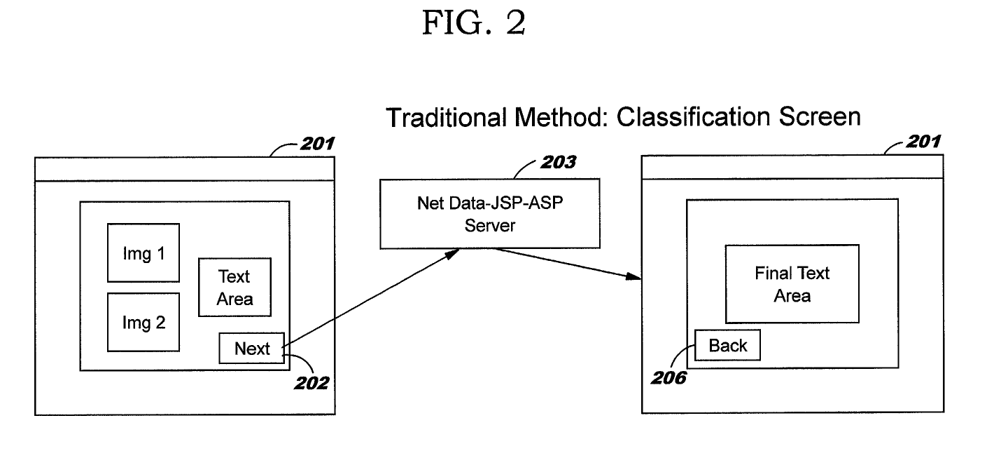

FIG. 2 illustrates a prior art representation of the web page layout with static, un-manipulable content, generated utilizing the above integrated code. The browser window 201 displays the web content 202 with included graphical images, Img1 and Img2, and text areas. Web content 202 also includes a NEXT button by which a following web page may be downloaded and displayed. With the presented content, a user is allowed to interact with the web content 202 by clicking on Img1 or Img2. Clicking on Img1 shows the text classifying Img1 and clicking on Img2 shows the text classifying Img2. Also, clicking on NEXT button triggers an interaction with the server 203 to generate and return the entire contents of next web page (or content) 206, which is displayed within browser window 201. Next Web content 206 is illustrated as a final text area and includes a BACK button that, when selected, reloads and displays web content 202.

The DHTML for the first screen (web content 202) does not utilize any frames. Instead, the DHTML uses the browser window 201 to house all of the information needed for the screen, including layout (e.g., where Img1 and Img2 are located on the screen), content (i.e., the physical graphics for Img1 and Img2), and logic (i.e., what happens when the user clicks on Img1 or Img2). Housing all of the information in the browser window requires a larger download time for all the information, which the present invention recognizes is unnecessary, especially when screens in a sequence share the same logic and/or layout.

The present invention thus implements a method by which only necessary information is downloaded for screens sharing similar logic and/or layouts that are downloaded in the sequence. The invention provides an HTML page that has two frames, a static (or engine) frame containing StaticContent and a dynamic (or control) frame containing DynamicContent that is initially an empty HTML page, but subsequently generated from a server-side scripting language.

The StaticContent frame is initialized to house a variable number of layers. Each layer is initially hidden. The StaticContent frame also references a Javascript library that contains functions to add, move, remove, show, hide, and otherwise change text, images, and other web media that will be housed in the layers of the StaticContent frame. When requested, the Net Data macro outputs simple Javascript functions to the DynamicContent frame resulting in viewable web content with logical behavior in the DynamicContent frame. The dynamic content references specific logic describing how the layers appear and interact for the particular screen.

In the preferred embodiment, the DynamicContent frame is populated with Javascript functions in a script generated from a server-side scripting language. To facilitate the merging of content, logic, and layout information in the generated script, the server-side scripting language includes separately stored information about content, logic, and layout, that is then provided to the DynamicContent frame.

The Net Data Macro (or other server-side scripting language), which simply generates Javascript functions, includes layout information defined in a separate XML, HTML, or Javascript file. The layout information file does not contain information about the server-side scripting language, content, or behavior of the screen. The layout information file is merely concerned with the display characteristics of the screen.

The content information file, in contrast, merely contains the web content to be displayed (i.e., URLs for images, actual text, etc). No information about the layout or logic of the screen is needed in this file.

Finally, the Javascript logic for the screen (also stored separately), does not require information about the server-side scripting language, layout, or content of the screen. This three-way separation ultimately results in a pure separation of logic, layout, and content for downloaded screens.

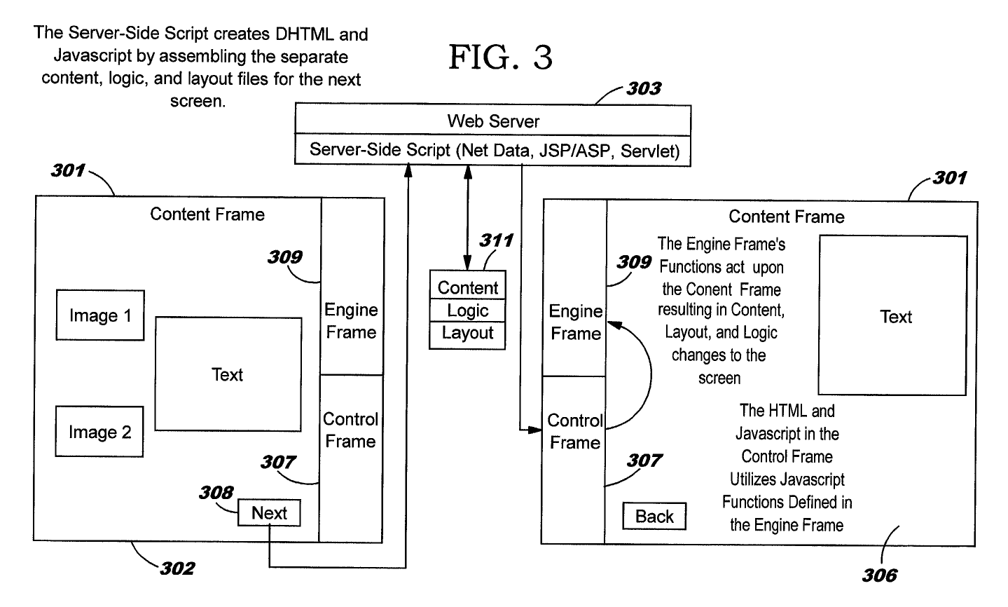

FIG. 3 illustrates one example of the implementation of the present invention by which web content (content frame) 302 is preferably displayed within browser window 301. The resulting web content 302, 306 are similar in appearance to the web content 202, 206, respectively, of FIG. 2. However, the design and functionality of web content 302, 306 of FIG. 3 are very different.

Web content 302, 306 are created utilizing frames (unlike the web content 202, 206 of FIG. 2, which does not utilize frames), with a top, content frame 302, 306 representing the merger of information from the control frame 307 and engine frame 309, intricately associated with the creation of the content frame 302, 306.

The content frame 302, 306 (i.e., the display layer) is utilized as a canvas to display images, audio layers, and textual information and appears similar to web content 202, 206 of FIG. 2. The content frame 302, 306 is initialized before the classification screen is displayed with N empty DHTML layers. The control frame is the “catcher” of the DynamicContent generated by the server (with server-side scripting languages). The engine frame 309 is initialized with the StaticContent including common logic and/or layout functions utilized by all screens (i.e., how to show/hide and image in a layer, write text into a layer, move a layer, etc.). Alternatively, in another embodiment the engine frame 309 and content frame 302, 306 may be merged together as a single frame.

The engine frame 309 holds onto the reusable behavior, and therefore, the download of DynamicContent may be optimized (i.e., shortened for download speed). Thus, instead of containing all of the DHTML that was originally required for the display screen to function, the generated content is merely HTML/Javascript function calls to the engine frame 309.

When next button 308 is selected, the web browser 301 accesses the web server 303, which has stored web page data 311, including content, logic and layout of the next web page(s). The web server 303 provides data for control frame 307 by downloading only DynamicContent to web browser 301. The server-side script creates Javascript and Visual Basic (VB) script by assembling the separate content, logic, and layout files for the next screen. The engine frame's functions act upon the DynamicContent received in the control frame 307 and causes changes in the content, layout and logic of the content frame 306. The HTML and Javascript in the control frame 307 utilizes Javascript functions defined in the engine frame 309 Additionally, in another embodiment, since a classification screen behaves differently from a text-only screen, the generated HTML/Javascript for the classification screen may optionally include a Javascript function library containing its unique behavior. Since the Javascript function library is imported from the generated HTML (rather than included within the generated DHTML), the library is downloaded only once, and is cached in the browser and reused for every classification.

The invention enables utilization of a tool such as Net Objects Fusion to return dynamically generated server-side content. Net Objects Fusion and other similar tools do not make assumptions about the manner in which the content is generated.

The present invention extends the interaction between static content and dynamic content one step further with the discovery that if web content is created as individual layers, there are increased gains in download time, and the content is easier to develop because the logic of the content is separated from the layout of the content. Sever-side logic is normally utilized for business logic, and utilization of the features of the invention provides enhanced functionality of the client logic, allowing the person writing the server logic to focus on the business logic and not on HTML/DHTML.

The invention separates the logic of a web screen from its layout and content. The server side scripting language (net data) dynamically generates content for the DynamicContent frame by including separately stored layout information, separately stored content information, and separately stored logic information.

The layout information is preferably an extensible Markup Language (XML) file, or other web file, that describes the pixel coordinates of each layer for the screen. The layout information also describes the initial visibility state of each layer, the fonts and colors, etc. For example, a classification image 1's pixel coordinates might be 10,20,200,100, and be visible. Classification text 1's pixel coordinates might be 400,400,200,300, have a 20 point font in blue, and be hidden. Classification audio 1's pixel location might be 100,400,100,50, and be visible.

The content information describes the media and text that the screen needs. For example, Classification image 1's image is “button.gif”. Classification text 1 is defined as “This is some classification text for Image 1”, and Classification audio 1's audio file is class1.mp3.

Finally, the logic of the screen is preferably a Javascript or VB script file that describes the behavior of the screen. For example, when the user clicks on classification image 1, the screen should show classification text 1 and play classification audio 1. Since this logic is the same for every classification screen, the browser only downloads the logic when the first classification screen is loaded. When the user enters subsequent classification screens, the server side scripting language will still include the classification logic file, but the browser will not downloaded the classification logic file again because the classification logic file is already in the browser's cache. In the preferred embodiment, the user enables the cache in his/her browser settings to store the classification logic file.

The subsequent classification screen does not need to directly follow the first classification screen. The subsequent classification screen could be 10 screens later, for example, and the browser will still keep the classification logic file cached.

The resulting performance gain enhances the user's experience. Instead of re-downloading a whole html page every time, the server side scripting language ultimately downloads Javascript functions that hide, show, resize, and move the text, image, and audio layers. Since a normal html page is not downloaded, the browser does not “flicker” or turn white before presenting the screen. Instead, the web content executes fluidly. On good Internet connections, the user will not be able to tell that the site is actually web content, because the resulting display looks and acts just like an executable program running on the client machine.

Separating the logic, content, and layout of the screen allows for an easy separation of roles and responsibilities for web site developers. With a development team, for example, writers and graphical artists develop the text and media for the content files, while courseware engineers separately develop the layout files, and programmers develop the logic files. By separating the various components as provided by the invention, the development team is able to create web content faster and cheaper because multiple people can work on the same site at the same time, and the logic files for the screens are re-used across many sites.

It is important to note that while the present invention has been described in the context of a fully functional data processing system, those skilled in the art will appreciate that the mechanism of the present invention is capable of being distributed in the form of a computer readable medium of instructions in a variety of forms, and that the present invention applies equally, regardless of the particular type of signal bearing media utilized to actually carry out the distribution. Examples of computer readable media include: nonvolatile, hard-coded type media such as Read Only Memories (ROMs) or Erasable, Electrically Programmable Read Only Memories (EEPROMs), recordable type media such as floppy disks, hard disk drives and CD-ROMs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of providing content for display of a web page, comprising:
generating a dynamic content frame separate from a static content frame comprising layout and logic information during development of said web page; and
downloading said dynamic content frame independently of said static content frame.

2. The method of claim 1, further comprising enabling a display of said web page by incorporating features of said dynamic content frame and said static content frame into a display frame.

3. The method of claim 2, wherein said downloading step restricts a download to only said dynamic content frame whenever said web page is requested to be downloaded in sequence with a second web page sharing similar layout and logic, whereby a previous static content frame is stored on the system requesting a download of said web page and more efficient download and display of said web page is achieved.

4. The method of claim 1, wherein said generating step comprises generating an HTML page with two frames, wherein:
a static content frame maintains layout information of a web page content and references an HTML file that includes a Javascript library to add, move, remove and change text and images in a display layer of said web page; and
a dynamic content frame created utilizing server-side scripting language that maintains changing information including text data, images, and audio data.

5. The method of claim 4, further comprising merging features of said static content frame and said dynamic content frame utilizing linking information provided within said dynamic content frame, wherein said linking information comprises HTML/Javascript function calls to said static content frame.

6. The method of claim 1, further comprising initializing said static content frame with common functions utilized by all screens, wherein said common functions include how to display and hide an image within a layer, how to write text into said layer, and how to move said layer.

7. The method of claim 1, further comprising:
importing a re-usable Javascript function library from a generated HTML to support a unique behavior of said display frame; and
caching said Javascript function library in a web browser with which said web page is downloaded, wherein said library may be utilized for subsequent classifications.

8. A computer program product comprising:
a computer readable medium; and
program code on said computer readable medium for providing content for display of a web page by:
generating a dynamic content frame separate from a static content frame comprising layout and logic information during development of said web page; and
downloading said dynamic content frame independently of said static content frame.

9. The computer program product of claim 8, further comprising program code for enabling a display of said web page by incorporating features of said dynamic content frame and said static content frame into a display frame.

10. The computer program product of claim 9, wherein said downloading program code restricts a download to only said dynamic content frame whenever said web page is requested to be downloaded in sequence with a second web page sharing similar layout and logic, whereby a previous static content frame is stored on the system requesting a download of said web page and more efficient download and display of said web page is achieved.

11. The computer program code of claim 8, wherein said generating program code comprises code for generating an HTML page with two frames, wherein:
a static content frame maintains layout information of a web page content and references an HTML file that includes a Javascript library to add, move, remove and change text and images in a display layer of said web page; and
a dynamic content frame created utilizing server-side scripting language that maintains changing information including text data, images, and audio data.

12. The computer program code of claim 11, further comprising program code for merging features of said static content frame and said dynamic content frame utilizing linking information provided within said dynamic content frame, wherein said linking information comprises HTML/Javascript function calls to said static content frame.

13. The computer program code of claim 8, further comprising program code for initializing said static content frame with common functions utilized by all screens, wherein said common functions include how to display and hide an image within a layer, how to write text into said layer, and how to move said layer.

14. The computer program code of claim 8, further comprising program code for:
importing a re-usable Javascript function library from a generated HTML to support a unique behavior of said display frame; and
caching said Javascript function library in a web browser with which said web page is downloaded, wherein said library may be utilized for subsequent classifications.

15. A method for extending interaction between static and dynamic content of a web page comprising:
creating said web page with individual layers corresponding each to web page content, and web page layout and logic; and
enabling manipulation of each layer by server-scripting software, wherein web page content may be changed by standard off-the-shelf scripting applications, without consideration of HTML and DHTML.

16. A system for providing content for display of a web page, comprising:
a server having a memory component with server software;
means for connecting a web browser to said server;
logic for generating a dynamic content frame utilizing a server-side scripting software separate from a static content frame comprising layout and logic information during development of a web page at said server; and
logic for downloading said dynamic content frame independently of said static content frame to said web browser via said connecting means.

17. The system of claim 16, wherein said downloading logic restricts a download to only said dynamic content frame whenever said web page is requested to be downloaded in sequence with a second web page sharing similar layout and logic, whereby a previous static content frame is stored on the web browser requesting a download of said web page, and wherein more efficient download and display of said web page is achieved.

18. The system of claim 16, wherein said generating logic comprises logic for generating an HTML page with two frames, wherein:
a static content frame maintains layout information of a web page content and references an HTML file that includes a Javascript library to add, move, remove and change text and images in a display layer of said web page; and
a dynamic content frame created utilizing server-side scripting language that maintains changing information including text data, images, and audio data.

19. The system of claim 4, further comprising means for incorporating a merge function that enables later merging of features of said static content frame and said dynamic content frame utilizing linking information provided within said dynamic content frame, wherein said linking information comprises HTML/Javascript function calls to said static content frame.

20. The system of claim 1, further comprising logic for initializing said static content frame with common functions utilized by all screens, wherein said common functions include how to display and hide an image within a layer, how to write text into said layer, and how to move said layer.

21. The system of claim 1, further comprising logic for:
exporting a re-usable Javascript function library from a generated HTML to support a unique behavior of said display frame, whereby said Javascript function library is cached in a web browser with which said web page is downloaded, wherein said library may be utilized for subsequent classifications.
